(19) United States
(12) Patent Application Publication
(10) Pub. No.: US 2022/0280889 A1
(43) Pub. Date: Sep. 8, 2022

(54) GRAVITATION SOLID EXCLUSION DEVICE

(71) Applicant: Re-Nuble, Inc., New York, NY (US)

(72) Inventor: Matthew FERRELL, New York, NY (US)

(73) Assignee: Re-Nuble, Inc., New York, NY (US)

(21) Appl. No.: 17/634,369

(22) PCT Filed: Aug. 13, 2020
(86) PCT No.: PCT/US2020/046241

§ 371 Date: Feb. 10, 2022

Related U.S. Application Data
(60) Provisional application No. 62/886,527, filed on Aug. 14, 2019.

(51) Int. Cl. B01D 21/00; B01D 21/02

(52) U.S. Cl. CPC B01D 21/0003; B01D 21/02

(57) ABSTRACT

The present disclosure relates to devices and systems for excluding solid impurities from liquids, methods of using the devices and systems, and methods of preparing the devices and systems.

### CROSS REFERENCE TO RELATED APPLICATION

This application claims priority to U.S. Provisional Application No. 62/886,527, filed on Aug. 14, 2019, the content of which is incorporated herein by reference in its entirety.

### FIELD

The present disclosure relates to devices and systems for excluding solid impurities from liquids, methods of using the devices and systems, and methods of preparing the devices and systems.

### BACKGROUND

Liquids used in agriculture, process engineering/manufacturing, and the wastewater industry often contain solid impurities. It is desirable to reduce the amount of solid impurities in liquids, but known devices for reducing the amount of solid impurities in liquids are bulky and difficult to move. Further, known devices often require regular maintenance due to accumulation of solids in the devices.

### SUMMARY

Devices and systems described herein exclude solid impurities from liquids and are easy to move, are less prone to solid accumulation, and require less maintenance.

In one aspect, provided herein is a solid exclusion device. In another aspect, provided herein is a solid exclusion system comprising the solid exclusion device disclosed therein. In another aspect, provided herein is a method of forming the solid exclusion device or system. In another aspect, provided herein is a method of excluding solid impurities from a liquid.

### BRIEF DESCRIPTION OF DRAWINGS

FIG. 1 shows a perspective view of a solid exclusion device.

FIG. 2 shows a solid exclusion device in a collapsed position.

FIG. 3 shows a section view of a solid exclusion system.

### DETAILED DESCRIPTION

Disclosed herein are devices and systems for excluding solid impurities from liquids, methods of using the devices and systems, and methods of preparing the devices and systems.

In the following description of examples, reference is made to the accompanying drawings which form a part hereof, and in which it is shown by way of illustration specific examples that can be practiced. It is to be understood that other examples can be used and structural changes can be made without departing from the scope of the disclosed examples.

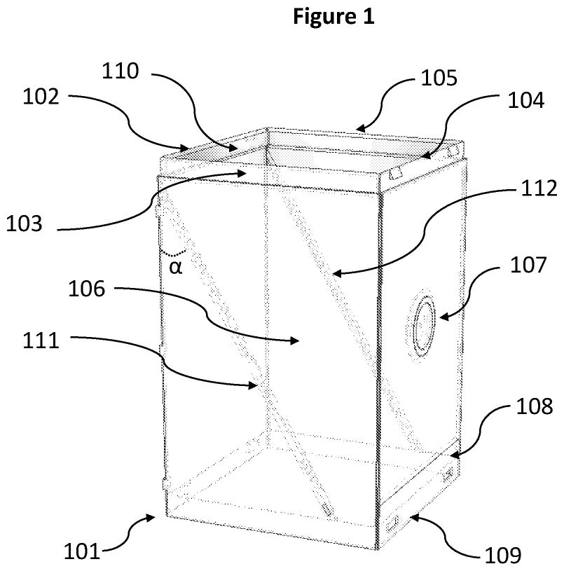

FIG. 1 shows a perspective view of an exemplary solid exclusion device 101. In some embodiments, the solid exclusion device 101 may include a first panel 102, a second panel 103 which is attachable to the first panel 102, a third panel 104 which is attachable to second panel 103, and a fourth panel 105 which is attachable to the third panel 104 and first panel 102. In some embodiments, the second panel 103 may include a first support 111. In some embodiments, the fourth panel 105 may include a second support 112.

In some embodiments, the wedge 106 which extends from a bottom 109 of the third panel 104 to a top 110 of the first panel 102, may be diagonally fixed between the second panel 103 and the fourth panel 105. In some embodiments, the wedge 106 may be fixed to the first support 111 and the second support 112 and diagonally fixed between the second panel 103 and the fourth panel 105. In some embodiments, the first support 111 and the second support 112 are support rails into which the wedge 116 can be slid. In some embodiments, the first support 111 and the second support 112 may each include an opening. The wedge 116 may include one or more teeth which may be engaged with the opening of the first support 111 and the opening of the second support 112. The wedge 116 may be fixed to the first support 111 and the second support 112 by engaging the teeth with the openings.

In some embodiments, the third panel 104 may include a first plug 107 which can be removed to form a first opening on the third panel 104 and a second plug 108 below the first plug 107 which can be removed to form a second opening on the third panel 104. In some embodiments, the second plug 108 is near the bottom 109 of the third panel 104 so that solids in the device 101 may exit the device from the second opening formed by removing the second plug 108. In some embodiments, the first plug 107 may be removed, thereby forming an opening. In some embodiments, the second plug 108 may be removed, thereby forming an opening. In some embodiments, the first plug 107 may be removed and the second plug 108 may be removed, thereby forming a first opening and a second opening, respectively. In some embodiments, the opening formed by removing the first plug 107 may be used as an outlet for the liquid to be processed by the device 101 and the opening formed by removing the second plug 108 may be used as an inlet for the liquid to be processed by the device 101.

In some embodiments, the plug 107 and plug 108 may be inserts. In some embodiments, the plug 107 and plug 108 may be parts of the panels that can be removed. In some embodiments, the plug 107 and plug 108 may be weakened pieces that can be removed.

Referring to FIG. 1, in some embodiments, an angle α between the first panel 102 and the wedge 106 is between 50° and 70°. In some embodiments, an angle α between the first panel 102 and the wedge 106 is about 60°. When a liquid is introduced into the device, the angle allows solids in the liquid to exit the device due to gravity. The angle also prevents friction and accumulation of the solids.

In some embodiments, an angle α between the first panel 102 and the wedge 106 is between 10° and 90°, between 20° and 90°, between 30° and 90°, between 40° and 90°, between 50° and 90°, between 60° and 90°, between 70° and 90°, between 10° and 80°, between 10° and 80°, between 20° and 80°, between 30° and 80°, between 40° and 80°, between 50° and 80°, between 60° and 80°, between 70° and 80°, between 10° and 70°, between 20° and 70°, between 30° and 70°, between 40° and 70°, between 50° and 70°, between 60° and 70°, between 10° and 60°, between 20° and 60°, between 30° and 60°, between 40° and 60°, between 50° and 60°, between 10° and 50°, between 20° and 50°, between 30° and 50°, between 40° and 50°, between 10° and 40°, between 20° and 40°, between 30° and 40°, between 10° and 30°, or between 20° and 30°. In some embodiments, an angle α between the first panel 102 and the wedge 106 is about 10°, about 20°, about 30°, about 40°, about 50°, about 60°, about 70°, or about 80°.

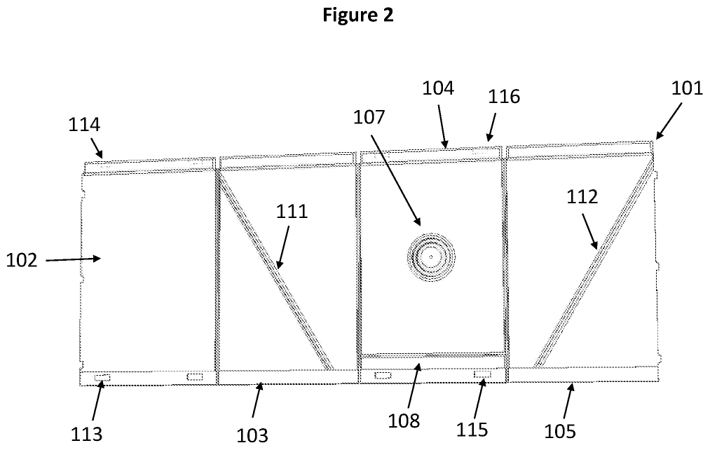

In some embodiments, the solid exclusion device 101 may be movable to a collapsed position by detaching one of the first panel 102, second panel 103, third panel 104, and fourth panel 105 from a panel to which it is attached to, and detaching the wedge 106 from the second panel 103 and the fourth panel 105. In some embodiments, the first panel 102 may be detached from the second panel 103. In some embodiments, the second panel 103 may be detached from the third panel 104. In some embodiments, the third panel 104 may be detached from the fourth panel 105. In some embodiments, the fourth panel 105 may be detached from the first panel 102. FIG. 2 shows an exemplary solid exclusion device 101 in a collapsed position. In some embodiments, the solid exclusion device in the collapsed position is flat. Therefore, the solid exclusion device can be easily moved or shipped in the collapsed position. It is understood that, as used herein, a flat device does not require a completely even device and a substantially even device with small lumps or indentations is also contemplated. In some embodiments, when the device is in the collapsed position, the panels may be folded and fit into a shipping container.

Referring to FIG. 2, in some embodiments, the solid exclusion device 101 may include an engagement means for attaching one solid exclusion device above another solid exclusion device. For example, the solid exclusion device 101 may be configured so that a first device may be inserted into bottom of a second device, thereby attaching the second device to the first device and positioning the second device above the first device. In some embodiments, the first panel 102 may include a bottom engagement means 113 and a top engagement means 114. The third panel 104 may include a bottom engagement means 115 and a top engagement means 116. The top engagement means 114 may be engaged with the bottom engagement means 113 or the bottom engagement means 115. The top engagement means 116 may be engaged with the bottom engagement means 113 or the bottom engagement means 115. It is understood that other arrangements are also contemplated. For example, in some embodiments, the second panel 103 may include a bottom engagement means and a top engagement means and the fourth panel 105 may include a bottom engagement means and a top engagement means. It is also understood that the engagement means on the first panel 102 and the third panel 104 are shown in FIG. 1 as an example and are not required.

In another aspect, provided is a method of forming the solid exclusion device as disclosed herein. Referring to FIG. 1, in some embodiments, a method may include forming a chamber defined by a first panel 102, a second panel 103 which is attached to the first panel 102, a third panel 104 which is attached to second panel 103, and a fourth panel 105 which is attached to the third panel 104 and first panel 102. A wedge 106, which extends from a bottom 109 of the third panel 104 to a top 110 of the first panel 102, may be diagonally fixed between the second panel 103 and the fourth panel 105. The third panel 104 may include a first plug 107 which can be removed to form a first opening on the third panel 104 and a second plug 108 below the first plug 107 which can be removed to form a second opening on the third panel 104. In some embodiments, the second plug 108 is near the bottom 109 of the third panel 104. In some embodiments, the first plug 107 may be removed and the second plug 108 may be removed, thereby forming a first opening and a second opening, respectively. An angle α between the first panel 102 and the wedge 106 is as disclosed herein.

In another aspect, provided is a method of excluding a solid impurity from a liquid using the solid exclusion device disclosed herein. Referring to FIG. 1, in some embodiments, the method may include passing a liquid through the solid exclusion device 101. In some embodiments, the first plug 107 may be removed and the second plug 108 may be removed, thereby forming a first opening and a second opening, respectively. The first opening formed by removing the first plug 107 may be used as an outlet for the liquid to be processed by the device and the second opening formed by removing the second plug 108 may be used as an inlet for the liquid to be processed by the device. After the liquid is introduced into the device 101 through the opening formed by removing the second plug 108, solid impurities fall to the bottom of the device 101 due to gravity and thus are separated from the liquid before the it exits through the opening formed by removing the first plug 107, thereby reducing the amount of solid impurities in the liquid exiting the solid exclusion device 101. The solid impurities separated from the liquid fall to the bottom of the solid exclusion device 101 and may exit the device through the opening formed by removing the second plug 108, thereby reducing the accumulation of the solids inside the device.

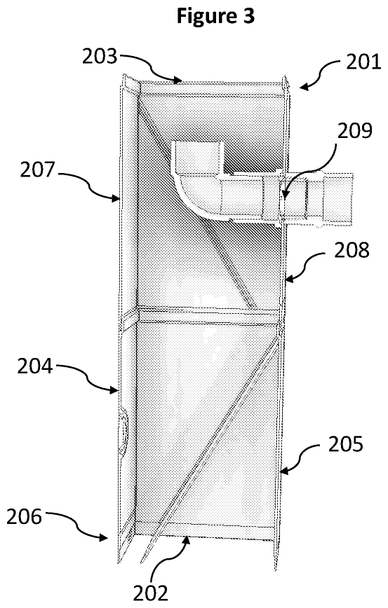

In another aspect, provided is a solid exclusion system which may include the solid exclusion device disclosed herein. FIG. 3 shows a section view of an exemplary solid exclusion system 201. The solid exclusion system 201 may include a first solid exclusion device 202 and a second solid exclusion device 203. The second solid exclusion device 203 may be attached to and positioned above the first solid exclusion device 202 and may be same as the first solid exclusion device 202. The second plug 206 on the third panel 204 of the first solid exclusion device 202 may be removed, thereby forming an opening on the third panel 204, which may be used as an inlet for the liquid to be processed by the system 201. The first plug 209 on the third panel 208 of the second solid exclusion device 203 may be removed, thereby forming an opening on the third panel 208 of the second solid exclusion device 203, which may be used as an outlet for the liquid to be processed to be processed by the system 201. In some embodiments, the first panel 207 of the second solid exclusion device 203 may be attached to the third panel 204 of the first solid exclusion device 202 and the third panel 208 of the second solid exclusion device 203 may be attached to the first panel 205 of the first solid exclusion device 202. It is understood that other arrangements are also contemplated. For example, the first panel 207 of the second solid exclusion device 203 may be attached to the first panel 205 of the first solid exclusion device 202 and the third panel 208 of the second solid exclusion device 203 may be attached to the third panel 204 of the first solid exclusion device 202. In some embodiments, a solid exclusion system may include more than two solid exclusion devices. For example, in some embodiments, a solid exclusion system may include three solid exclusion devices disclosed herein, where a second device is attached to and positioned above a first device and a third device is attached to and positioned above the second device. It is also understood that, in some embodiments of a solid exclusion system, the first solid exclusion device and the second solid exclusion device may be different. For example, in some embodiments, the first solid exclusion device may have a plug near the bottom of the third panel and the second solid exclusion device may have a plug in a higher position relative to the bottom of the third panel. It is also understood that the engagement means on the third panel 204 and the first panel 205 and the pipe in the opening formed by removing the first plug 209 are shown as an example and are not required.

In another aspect, provided is a method of forming a solid exclusion system. In some embodiments, the method may include forming a first chamber and a second chamber which is attached to and positioned above the first chamber. In some embodiments, the first chamber may include a first panel of the first chamber, a second panel of the first chamber which is attached to the first panel of the first chamber, a third panel of the first chamber which is attached to the second panel of the first chamber, a fourth panel of the first chamber which is attached to the third panel of the first chamber and the first panel of the first chamber, and a wedge of the first chamber diagonally fixed between the second panel of the first chamber and the fourth panel of the first chamber and extending from a bottom of the third panel of the first chamber to a top of the first panel of the first chamber, wherein the third panel of the first chamber comprises an opening near the bottom of the third panel of the first chamber. In some embodiments, the second chamber may include a first panel of the second chamber, a second panel of the second chamber which is attached to the first panel of the second chamber, a third panel of the second chamber which is attached to the second panel of the second chamber, a fourth panel of the second chamber, which is attached to the third panel of the second chamber and the first panel of the second chamber, and a wedge of the second chamber diagonally fixed between the second panel of the second chamber and the fourth panel of the second chamber and extending from a bottom of the third panel of the second chamber to a top of the first panel of the second chamber, wherein the third panel of the second chamber comprises an opening. In some embodiments, the first panel of the second chamber is attached to the third panel of the first chamber; and the third panel of the second chamber is attached to the first panel of the first chamber. In some embodiments, an angle between the first panel of the first chamber and the wedge of the first chamber is between 50° and 70°; and an angle between the first panel of the second chamber and the wedge of the second chamber is between 50° and 70°. In some embodiments, the angle between the first panel of the first chamber and the wedge of the first chamber is about 60°; and the angle between the first panel of the second chamber and the wedge of the second chamber is about 60°.

In some embodiments, the method may include forming a first solid exclusion device and a second solid exclusion device according to the methods disclosed herein, wherein the second solid exclusion device may be attached to and positioned above the first solid exclusion device and may be same as the first solid exclusion device. Referring to FIG. 3, in some embodiments, the first panel 207 of the second solid exclusion device 203 may be attached to the third panel 204 of the first solid exclusion device 202 and the third panel 208 of the second solid exclusion device 203 may be attached to the first panel 205 of the first solid exclusion device 202. In some embodiments, the method may include removing the second plug 206 on the third panel 204 of the first solid exclusion device 202 may be thereby forming an opening on the third panel 204, which may be used as an inlet for the liquid to be processed by the system 201, and removing the first plug 209 on the third panel 208 of the second solid exclusion device 203, thereby forming an opening on the third panel 208 of the second solid exclusion device 203, which may be used as an outlet for the liquid to be processed. It is understood that other arrangements are also contemplated as disclosed herein.

In another aspect, provided is a method of excluding a solid impurity from a liquid using the solid exclusion system disclosed herein. Referring to FIG. 3, in some embodiments, the method may include passing a liquid through the solid exclusion system 201. The second plug 206 on the third panel 204 of the first solid exclusion device 202 may be removed, thereby forming an opening on the third panel 204, which may be used as an inlet for the liquid to be processed by the system 201. The first plug 209 on the third panel 208 of the second solid exclusion device 203 may be removed, thereby forming an opening on the third panel 208 of the second solid exclusion device 203, which may be used as an outlet for the liquid to be processed. After the liquid is introduced into the solid exclusion system 201 through the opening formed by removing the second plug 206 on the third panel 204 of the first solid exclusion device 202, solid impurities fall to the bottom of the first solid exclusion device 202 due to gravity and thus are separated from the liquid before it exits through the opening formed by removing the first plug 209 on the third panel 208 of the second solid exclusion device 203, thereby reducing the amount of solid impurities in the liquid exiting the solid exclusion system 201. The solid impurities separated from the liquid fall to the bottom of the first solid exclusion device 202 and may exit the system through the opening formed by removing the second plug 206 on the third panel 204 of the first solid exclusion device 202, thereby reducing the accumulation of the solids inside the system.

Exemplary embodiments are provided below.

Embodiment 1. A solid exclusion device, comprising:
a first panel;
a second panel attachable to the first panel and comprising a first support;
a third panel attachable to the second panel, comprising:

a first plug which can be removed to form a first opening on the third panel, and

a second plug below the first plug, wherein the second plug can be removed to form a second opening on the third panel;

a fourth panel attachable to the third panel and the first panel and comprising a second support; and
a wedge fixable to the first support and the second support and between the second panel and the fourth panel, the wedge extending from a bottom of the third panel to a top of the first panel, wherein the second plug is near the bottom of the third panel.
Embodiment 2. The solid exclusion device of embodiment 1, wherein the solid exclusion device is movable to a collapsed position by detaching the first panel from the second panel, the second panel from the third panel, the third panel from the fourth panel, or the fourth panel from the first panel; and detaching the wedge from the second panel and the fourth panel.
Embodiment 3. The solid exclusion device of embodiment 2, wherein the solid exclusion device is flat in the collapsed position.
Embodiment 4. The solid exclusion device of any one of embodiments 1-3, wherein when the wedge is fixed between the second panel and the fourth panel, an angle between the first panel and the wedge is between 50° and 70°.
Embodiment 5. The solid exclusion device of embodiment 4, wherein the angle between the first panel and the wedge is about 60°.
Embodiment 6. A solid exclusion system, comprising:
a first solid exclusion device and a second solid exclusion device, wherein the first solid exclusion device and the second solid exclusion device are the same as each other and as defined in any one of embodiments 1-5, and wherein:
the second solid exclusion device is attached to and positioned above the first solid exclusion device.
Embodiment 7. The solid exclusion system of embodiment 6, wherein:
the first panel of the second solid exclusion device is attached to the third panel of the first solid exclusion device; and
the third panel of the second solid exclusion device is attached to the first panel of the first solid exclusion device.
Embodiment 8. A method of forming a solid exclusion device, comprising:
forming a chamber by attaching a first panel to a second panel, attaching a third panel to the second panel, and attaching a fourth panel to the third panel and the first panel, wherein the third panel comprises a first opening and a second opening below the first opening; and
fixing a wedge between the second panel and the fourth panel so that the wedge diagonally extends from a bottom of the third panel to a top of the first panel, wherein the second opening is near the bottom of the third panel.
Embodiment 9. The method of embodiment 8, wherein an angle between the first panel and the wedge is between 50° and 70°.
Embodiment 10. The method of embodiment 9, wherein the angle between the first panel and the wedge is about 60°.
Embodiment 11. A method of forming a solid exclusion system, comprising:
providing a first chamber comprising:

a first panel,

a second panel attachable to the first panel,

a third panel attachable to the second panel and comprising an opening near a bottom of the third panel,

a fourth panel attachable to the third panel;

fixing a wedge diagonally between the second panel of the first chamber and the fourth panel of the first chamber, the wedge extending from a bottom of the third panel of the first chamber to a top of the first panel of the first chamber,
providing a second chamber comprising:

a first panel,

a second panel attachable to the first panel,

a third panel attachable to the second panel and comprising an opening,

a fourth panel attachable to the third panel;

fixing a wedge diagonally between the second panel of the second chamber and the fourth panel of the second chamber, the wedge extending from a bottom of the third panel of the second chamber to a top of the first panel of the second chamber,
positioning the second chamber above the first chamber; and
attaching the first and second chambers.
Embodiment 12. The method of embodiment 11, wherein providing the first chamber comprises:
attaching the first panel of the first chamber to the second panel of the first chamber,
attaching the second panel of the first chamber to the third panel of the first chamber,
attaching the third panel of the first chamber to the fourth panel of the first chamber, or
attaching the fourth panel of the first chamber to the first panel of the first chamber.
Embodiment 13. The method of embodiment 11 or 12, wherein providing the second chamber comprises:
attaching the first panel of the second chamber to the second panel of the second chamber,
attaching the second panel of the second chamber to the third panel of the second chamber,
attaching the third panel of the second chamber to the fourth panel of the second chamber, or
attaching the fourth panel of the second chamber to the first panel of the second chamber.
Embodiment 14. The method of any one of embodiments 11-13, wherein:
the first panel of the second chamber is attached to the third panel of the first chamber; and
the third panel of the second chamber is attached to the first panel of the first chamber.
Embodiment 15. The method of any one of embodiments 11-14, wherein:
an angle between the first panel of the first chamber and the wedge of the first chamber is between 50° and 70°; and
an angle between the first panel of the second chamber and the wedge of the second chamber is between 50° and 70°.
Embodiment 16. The method of embodiment 15, wherein
the angle between the first panel of the first chamber and the wedge of the first chamber is about 60°; and
the angle between the first panel of the second chamber and the wedge of the second chamber is about 60°.
Embodiment 17. A method of excluding a solid impurity from a liquid, comprising:
passing the liquid through the solid exclusion device of any one of embodiments 1-5, wherein the first opening is an outlet for the liquid and the second opening is an inlet for the liquid.
Embodiment 18. A method of excluding a solid impurity from a liquid, comprising:
passing the liquid through the solid exclusion system of embodiment 6 or 7, wherein:
the opening on the third panel of the first solid exclusion device is an inlet for the liquid, and
the opening on the third panel of the second solid exclusion device is an outlet for the liquid.

In the above description of embodiments, reference is made to the accompanying drawings which form a part hereof, and in which specific embodiments that can be practiced are shown by way of example. Although the disclosed embodiments have been fully described with reference to the accompanying drawings, it is to be noted that various changes and modifications will become apparent to those skilled in the art. Such changes and modifications are to be understood as being included within the scope of the disclosed embodiments as defined by the appended claims. It should be understood that the various embodiments have been presented by way of example only, and not by way of limitation. Likewise, the various diagrams may depict an example architectural or other configuration for the embodiments, which is done to aid in understanding the features and functionality that can be included in the disclosed embodiments. The disclosure is not restricted to the illustrated example architectures or configurations, but can be implemented using a variety of alternative architectures and configurations. Additionally, although the invention is described above in terms of various exemplary embodiments and implementations, it should be understood that the various features and functionality described in one or more of the individual embodiments are not limited in their applicability to the particular embodiment with which they are described. They instead can be applied alone, or in some combination, to one or more of the other embodiments of the invention, whether or not such embodiments are described, and whether or not such features are presented as being a part of a described embodiment. Thus the breadth and scope of the invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; and adjectives such as “conventional,” “traditional,” “normal,” “standard,” “known,” and terms of similar meaning, should not be construed as limiting the item described to a given time period, or to an item available as of a given time. But instead these terms should be read to encompass conventional, traditional, normal, or standard technologies that may be available, known now, or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated. For example, “at least one” may refer to a single or plural and is not limited to either. The presence of broadening words and phrases such as “one or more,” “at least,” “but not limited to,” or other like phrases in some instances shall not be read to mean that the narrower case is intended or required in instances where such broadening phrases may be absent. The word “exemplary” is used herein to mean “serving as an example or illustration.” Any aspect or design described herein as “exemplary” is not necessarily to be construed as preferred or advantageous over other aspects or designs. As used herein, the singular forms “a”, “an” and “the” include plural forms, unless the context clearly dictates otherwise. As used herein, and unless otherwise specified, the term “about,” when used in connection with a specified value, is meant to include a value within 5%, within 4%, within 3%, within 2%, within 1%, within 0.5%, or within 0.1% of the specified value. As used herein, and unless otherwise specified, “excluding a solid impurity” is meant to include reducing the amount of a solid impurity or eliminating a solid impurity.

What is claimed is:

1. A solid exclusion device, comprising:
a first panel;
a second panel attachable to the first panel and comprising a first support;
a third panel attachable to the second panel, comprising:
a first plug which can be removed to form a first opening on the third panel, and
a second plug below the first plug, wherein the second plug can be removed to form a second opening on the third panel;
a fourth panel attachable to the third panel and the first panel and comprising a second support; and
a wedge fixable to the first support and the second support and between the second panel and the fourth panel, the wedge extending from a bottom of the third panel to a top of the first panel, wherein the second plug is near the bottom of the third panel.

2. The solid exclusion device of claim 1, wherein the solid exclusion device is movable to a collapsed position by detaching the first panel from the second panel, the second panel from the third panel, the third panel from the fourth panel, or the fourth panel from the first panel; and detaching the wedge from the second panel and the fourth panel.

3. The solid exclusion device of claim 2, wherein the solid exclusion device is flat in the collapsed position.

4. The solid exclusion device of claim 1, wherein when the wedge is fixed between the second panel and the fourth panel, an angle between the first panel and the wedge is between 50° and 70°.

5. The solid exclusion device of claim 4, wherein the angle between the first panel and the wedge is about 60°.

6. A solid exclusion system, comprising:
a first solid exclusion device and a second solid exclusion device, wherein the first solid exclusion device and the second solid exclusion device are the same as each other and as defined in claim 1, and wherein:
the second solid exclusion device is attached to and positioned above the first solid exclusion device.

7. The solid exclusion system of claim 6, wherein:
the first panel of the second solid exclusion device is attached to the third panel of the first solid exclusion device; and
the third panel of the second solid exclusion device is attached to the first panel of the first solid exclusion device.

8. A method of forming a solid exclusion device, comprising:
forming a chamber by attaching a first panel to a second panel, attaching a third panel to the second panel, and
attaching a fourth panel to the third panel and the first panel, wherein the third panel comprises a first opening and a second opening below the first opening; and
fixing a wedge between the second panel and the fourth panel so that the wedge diagonally extends from a bottom of the third panel to a top of the first panel, wherein the second opening is near the bottom of the third panel.

9. The method of claim 8, wherein an angle between the first panel and the wedge is between 50° and 70°.

10. The method of claim 9, wherein the angle between the first panel and the wedge is about 60°.

11. A method of forming a solid exclusion system, comprising:
providing a first chamber comprising:
a first panel,
a second panel attachable to the first panel,
a third panel attachable to the second panel and comprising an opening near a bottom of the third panel,
a fourth panel attachable to the third panel;
fixing a wedge diagonally between the second panel of the first chamber and the fourth panel of the first chamber, the wedge extending from a bottom of the third panel of the first chamber to a top of the first panel of the first chamber,
providing a second chamber comprising:
a first panel,
a second panel attachable to the first panel,
a third panel attachable to the second panel and comprising an opening, a fourth panel attachable to the third panel;
fixing a wedge diagonally between the second panel of the second chamber and the fourth panel of the second chamber, the wedge extending from a bottom of the third panel of the second chamber to a top of the first panel of the second chamber,
positioning the second chamber above the first chamber; and
attaching the first and second chambers.

12. The method of claim 11, wherein providing the first chamber comprises:
attaching the first panel of the first chamber to the second panel of the first chamber,
attaching the second panel of the first chamber to the third panel of the first chamber,
attaching the third panel of the first chamber to the fourth panel of the first chamber, or
attaching the fourth panel of the first chamber to the first panel of the first chamber.

13. The method of claim 11, wherein providing the second chamber comprises:
attaching the first panel of the second chamber to the second panel of the second chamber,
attaching the second panel of the second chamber to the third panel of the second chamber,
attaching the third panel of the second chamber to the fourth panel of the second chamber, or
attaching the fourth panel of the second chamber to the first panel of the second chamber.

14. The method of claim 11, wherein:
the first panel of the second chamber is attached to the third panel of the first chamber; and
the third panel of the second chamber is attached to the first panel of the first chamber.

15. The method of claim 11, wherein:
an angle between the first panel of the first chamber and the wedge of the first chamber is between 50° and 70°; and
an angle between the first panel of the second chamber and the wedge of the second chamber is between 50° and 70°.

16. The method of claim 15, wherein
the angle between the first panel of the first chamber and the wedge of the first chamber is about 60°; and
the angle between the first panel of the second chamber and the wedge of the second chamber is about 60°.

17. A method of excluding a solid impurity from a liquid, comprising:
passing the liquid through the solid exclusion device of claim 1, wherein the first opening is an outlet for the liquid and the second opening is an inlet for the liquid.

18. A method of excluding a solid impurity from a liquid, comprising:
passing the liquid through the solid exclusion system of claim 6, wherein:
the opening on the third panel of the first solid exclusion device is an inlet for the liquid, and
the opening on the third panel of the second solid exclusion device is an outlet for the liquid.

19. A method of excluding a solid impurity from a liquid, comprising:
passing the liquid through the solid exclusion system of claim 7, wherein:
the opening on the third panel of the first solid exclusion device is an inlet for the liquid, and
the opening on the third panel of the second solid exclusion device is an outlet for the liquid.

20. The method of claim 12, wherein providing the second chamber comprises:
attaching the first panel of the second chamber to the second panel of the second chamber,
attaching the second panel of the second chamber to the third panel of the second chamber,
attaching the third panel of the second chamber to the fourth panel of the second chamber, or
attaching the fourth panel of the second chamber to the first panel of the second chamber.
